(19) United States
(12) Patent Application Publication
(10) Pub. No.: US 2025/0056677 A1
(43) Pub. Date: Feb. 13, 2025

(54) Electrical Heating Device

(71) Applicant: Eberspächer catem GmbH & Co. KG, Herxheim (DE)

(72) Inventors: Kai-Fabian Bürkle, Hinterweidenthal (DE); Markus Hoffmann, Beindersheim (DE); Jikang Wang, Rülzheim (DE); Gaetan Ahoufack, Pirmasens (DE); Timo Kröner, Rülzheim (DE); Ralf Lothar Weinand, Wörth am Rhein (DE); Sascha Herzig, Bad Bergzabern (DE); Ahmad Asafi, Karlsruhe (DE); Andreas Bachmann, Böhl-Iggelheim (DE); Fabian Beck, Landau in der Pfalz (DE); Carina Bauer, Bellheim (DE)

(21) Appl. No.: 18/798,967

(22) Filed: Aug. 9, 2024

(30) Foreign Application Priority Data
Aug. 10, 2023 (DE) 10 2023 121 381.4
Aug. 10, 2023 (DE) 10 2023 121 384.9

(51) Int. Cl. H05B 3/14; H05B 3/26

(52) U.S. Cl. CPC H05B 3/141; H05B 3/262; H05B 2203/02; H05B 2203/021

(57) ABSTRACT

An electrical heating device comprises two heating chambers between which an electrical heating assembly is formed. Via a distributor a flow of a medium to be heated entering the electrical heating device in the inflow direction is divided into a first partial flow and a second partial flow. The first partial flow flows through the first heating chamber, while the second partial flow flows through the second heating chamber. For this purpose, the distributor has a distributing body, which may be configured as a conical bod that is rotationally symmetrical about an axis of symmetry. The axis of symmetry may be parallel to an inlet axis. Alternatively, the distributing body can also be configured as an overflow edge.

### BACKGROUND OF THE INVENTION

### 1. Field of the Invention

The present invention relates to an electrical heating device for heating a liquid medium comprising a first heating chamber and a second heating chamber and an electrical heating assembly provided between the first heating chamber and the second heating chamber and coupled to the first heating chamber and the second heating chamber in a heat-conducting manner.

### 2. Discussion of the Related Art

Such electrical heating devices are known, for example, from EP 2 599 573 A1. The heating device described there comprises an electrical heating assembly which is formed between two heating chambers. According to this prior art, the heating chambers are flowed through one after the other. This results in a different temperature variance of the medium to be heated relative to the heating device in the two heating chambers. The medium flowing through the first heating chamber is considerably cooler than the medium flowing through the second heating chamber. This results in uneven heat dissipation of the heat generated in the electrical heating assembly to the medium.

On this basis, the problem underlying the present invention is to provide an electrical heating device which is improved with respect to uniform heat dissipation of the heating device.

### SUMMARY

In order to solve this problem, an electrical heating device for heating a liquid medium is proposed, comprising a first heating chamber and a second heating chamber and an electrical heating assembly which is provided between the first heating chamber and the second heating chamber and is coupled to the first heating chamber and the second heating chamber in a heat-conducting manner, wherein a distributor is formed through which the medium is distributed between the first heating chamber and the second heating chamber, wherein the distributor comprises a distributing body through which the medium introduced into the distributor is divided into a first partial flow which is conducted into the first heating chamber and a second partial flow which is conducted into the second heating chamber.

The electrical heating device may be a flat or planar electrical heating device, in which an electrical heating assembly comprising at least one electrically operable heating element is present, on each longitudinal side of which a heating chamber with a flow path for the medium to be heated is arranged. The heating device is thus flat, in particular configured as a type of cuboid, which has two longitudinal sides that are significantly larger than the edge sides connecting the longitudinal sides, in particular larger by at least a factor of 5.

The at least one electrical heating element is an electrically heatable heating element, typically a resistance heating element or a PTC element. In this case, the heating device and it's at least one heating element lie in one plane, while each heating chamber with its at least one flow path lies in a heating chamber plane that is aligned parallel to the plane of the heating elements or heating device.

A PTC element is made of a material with a positive temperature coefficient (PTC) and may be in the form of a ceramic cuboid component. The cuboid component has two main side surfaces that are aligned parallel to each other and are connected to each other via peripheral sides. Each main side surface is larger than the surfaces of the peripheral sides by at least a factor of 5, typically even than the sum of the surfaces of all peripheral sides. Each main side surface is provided with a metallization for energization, against which an electrically conductive contact layer, typically a contact sheet, abuts. An electrically insulating layer is formed on the side of the contacting layer opposite the corresponding main side surface, which effects electrical insulation of the contacting layer. The contacting layer can also be formed as an electrically conductive coating on the electrically insulating layer. In other words, the contacting layer and the electrical insulating layer according to the present invention may be formed by a unitary component providing multiple functional areas. In any case, the PTC elements are applied in an electrically conductive manner against the contacting layer and are energized via the same. Alternatively, other electrically heatable heating elements can be used as at least one heating element instead of PTC elements, typically resistance heating elements. A configuration in which the heating device comprises at least one PTC element is most typical.

The heating chambers may be made of a metallic material, typically of an aluminum-containing material, in particular by a casting or die-casting process. The electrical heating device of the present invention is particularly suitable for operation with a high-voltage current, such as that used for drives in electric vehicles. In particular, according to the present invention, a current with more than 400 volts, optionally more than 700 volts, is considered to be a high-voltage current.

The distributor according to the present invention allows the medium to be divided into two partial flows, which flow simultaneously and in the same direction through the two heating chambers of the electrical heating device. This is achieved by the distributing body, which divides the flow of medium impinging on it and diverts the first partial flow in the direction of the first heating chamber and the second partial flow in the direction of the second heating chamber. Due to the simultaneous flow around the heating device through the heating chambers formed on both longitudinal sides, the medium flows into both heating chambers at an identical temperature and is then heated in both heating chambers. The disadvantage known from the prior art of the large difference between the temperature of the medium flowing into the first heating chamber compared to the temperature of the medium flowing into the second heating chamber is thus overcome. This enables a more uniform heating of the medium compared to the prior art and at the same time a more uniform heat dissipation of the heating device into both heating chambers.

In this context, the distributing body may be configured such that the two partial flows differ from each other by a maximum of 10%, preferably by a maximum of 5%, more typically by a maximum of 2%. It is most typical to divide the medium into two partial flows of the same size, so that an identical partial flow of the medium flows through both heating chambers. In this way, uniform heating of the medium can be achieved in both heating chambers.

The flow guidance in the electrical heating device for the medium to be heated may be formed such that there is a very low pressure loss between an inlet and an outlet. The inlet and outlet are usually formed by nozzles via which a hose or pipe is connected to the electrical heating device. The pressure loss is therefore the pressure loss of the total medium flowing through the heating device. By avoiding corners and a sharp-edged deflection in the flow, the low-loss division of the total incoming flow into the partial flows and flow guide ribs within the respective heating chamber, it is possible to keep the pressure loss low. Under flow condition 10 1/min of water at 50° C. flowing through the electrical heating device, the pressure difference between flow inlet and flow outlet of the electrical heating device may not be higher than 100 mbar, preferably not higher than 55 mbar and most preferably not higher than 18 mbar. The flow guide ribs can direct and guide the flow within the heating chamber, resulting in a vortex-free flow. However, a flow guide rib can also define separate flow channels within the heating chamber and between the inlet and outlet to the corresponding heating chamber. The heating chambers are generally configured identically.

In a heating chamber cover covering the first heating chamber on the side opposite the heating device, an inlet may be formed which is flow-connected to the distributor. The inlet typically covers the distributing body. The supply of the medium to be heated through a heating chamber cover, which is formed on the side opposite the heating assembly and closes a heating chamber in a fluid-tight manner, allows a compact structure of the electrical heating device. The inlet is flow-connected to the distributor, thus, the medium first flows into the distributor and is then divided by the distributor into the two partial flows, which then flow into the two heating chambers. If the inlet covers the distributing body, this causes the medium flowing through the inlet to impinge directly on the distributing body. This means that the distributor can be simply constructed and easily connected to the inlet.

The distributor may be formed in a plane containing the first heating chamber, most typically in a configuration in which an inlet is formed in a heating chamber cover covering the first heating chamber on the side opposite the heating device, which inlet is flow-connected to the distributor. This enables a compact structure and a simple structural connection between inlet and distributor. The distributor may be located in the plane containing the first heating chamber. The distributor may be connected to an inlet flow connection, which connects the distributor to the second heating chamber, wherein the inlet flow connection penetrates a plane containing the heating device. The inlet flow connection is usually a flow connection that extends strictly at right angles to the plane containing the heating device and then usually penetrates this plane. The same applies to an outlet flow connection, which is formed on the outlet side but is otherwise usually configured identically to the inlet flow connection. In this way, the second partial flow can be conveyed in the direction of the second heating chamber in a simple manner, and a compact and structurally simple structure of the electrical heating device is achieved. The medium to be heated is fed from one side of the electrical heating device and distributed to both heating chambers in the distributor.

The distributor may have an inlet distributor section that is flow-connected to an inlet branch of the first heating chamber and the inlet flow connection. In this context, thee distributing body typically is formed between the inlet distributor section and the inlet branch of the first heating chamber. The inlet distributor section extends in the plane containing the first heating chamber between the distributing body and the inlet flow connection. In the same way, an outlet distributor section may be formed by the distributor, which may extend in the plane containing the first heating chamber between the distributing body and the outlet flow connection.

This further development then results in the flow connections extending transversely to the plane containing the heating device and the inlet and outlet flow connections extending parallel to this plane, specifically in the plane containing the first heating chamber. The distributor sections may be arranged axially symmetrically to one another, generally relative to a longitudinal axis of the housing, which has the largest extension in the plane containing the heating chamber or in the plane containing the heating device. These planes are usually parallel to each other in the electrical heating device.

The distributor sections may have an approximate triangular ground area in a top view of the plane containing the first heating chamber. It is understood that this triangular ground area is provided with rounded corners. The area usually referred to as the tip of the triangle is rounded and may be provided adjacent to the distributing body, which is usually located on an edge of the triangular ground area. The respective flow connections are provided opposite the rounded tip of the triangular ground area.

An overflow edge may be formed as the distributing body in one embodiment. An overflow edge is easy to form. At the same time, it can be aligned in such a way that a largely equal distribution to both partial flows is achieved. This can be realized, for example, in that the flow of medium flowing into the distributor flows centrally towards the overflow edge and the overflow edge is aligned such that each flank of the overflow edge sends the partial flow in the direction of a heating chamber.

The overflow edge may pass centrally through an inlet in the distributor. This means that the inlet or a projection of the inlet onto the distributing body cuts centrally through the overflow edge, thus dividing the inlet or the projection of the inlet onto the overflow edge into two equally sized halves. This makes it easy to achieve a largely uniform division of the medium into two partial flows.

In a further embodiment, a conical body that is rotationally symmetrical to an axis of symmetry may be configured as a distributing body. In this case, the conical body has a shell surface that ends in a tip. The tip lies on the axis of symmetry. In a possible variant, the shell surface in this context has a straight generatrix, that is, a straight outer boundary of the conical shell. In this case, the conical body is a straight cone, for example. In a further variant, the generatrix is curved. In particular, the shell surface of the conical body is concave. The configuration of the distributing body as a rotationally symmetrical conical body allows precise adaptation of the distribution to the two partial flows to the respective fluid dynamic conditions downstream of the distributing body. In particular by adapting the shape of the conical body, that is, in particular the diameter of the circular base and/or the height of the conical body and/or the shape of the shell surface, it is possible to precisely adapt the division of the flow of medium into the two partial flows. A good distribution of the partial flows can be achieved in particular by means of a concave shell surface, in particular a division into two partial flows of essentially the same size can be achieved.

The axis of symmetry of the conical body may be parallel or collinear to a direction in which the flow of medium impinges on the distributing body. In particular, the axis of symmetry of the conical body corresponds to an axis of symmetry of an inlet or an inlet nozzle via which the medium is fed into the distributor. Alternatively or additionally, the axis of symmetry corresponds to a direction of flow of the medium into the distributor. Alternatively or additionally, the conical body is formed centrally to an inlet to the distributor. These measures result in the fact that the flow of the medium flows centrally and straight towards the distributing body, so that a precise division of the flow into the two partial flows is achieved. The conical body may be formed centrally to an inlet or inlet nozzle for the medium, so that the flow is directed centrally against the tip of the conical body.

Partial flows coming from the first heating chamber and from the second heating chamber may be brought together by the distributor. For this purpose, the distributor may have a further distributing body, which may be configured and positioned as described above. This further distributing body causes the two partial flows to be brought together to form a flow of medium, which then leaves the electrical heating device through an outlet, typically formed in a heating chamber cover, and possibly through an outlet nozzle. For the relationship of this further distributing body to the outlet and/or the outlet nozzle, the above applies to the relationship of the distributing body to the inlet and/or inlet nozzle. Furthermore, the above applies to the further distributing body with regard to shape, size and alignment.

According to a possible further development of the present invention, the first heating chamber is formed between a housing bottom of a housing base part and a heating chamber cover which is connected to the housing base part. This connection is usually such that the interior of the housing is hermetically sealed from the environment. The housing base part usually forms the inlet and outlet for the medium to be heated. The second heating chamber may be formed by a fluid housing, which is usually located in the housing. The housing base part usually forms a distributor through which the medium introduced through the inlet is divided into partial flows to the first heating chamber and to the second heating chamber and through which the partial flows coming from the first heating chamber and from the second heating chamber are brought together. This distributor is usually located on one side of the fluid housing or to the side of the heating device. Accordingly, the flow is guided in a ring shape over the ground area of the heating device. The distributor is usually located outside a ground area of the flat heating device. The distributor is usually arranged in a plane containing the first heating chamber. In other words, the partial flow coming from the inlet is discharged directly at the level of the first heating chamber by an inlet channel introducing the medium into the electrical heating device and is also returned at this level via an outlet channel. The corresponding configuration ensures a through-flow of the electrical heating device with relatively low flow resistance and thus loss of efficiency. The housing base part may be connected to an inlet nozzle leading to the inlet and an outlet nozzle communicating with the outlet. These nozzles can be screwed, riveted, welded, soldered or glued to the housing base part, which is configured as a cast or deep-drawn part, or connected in some other way to form a single part. The nozzles are used to connect the electrical heating device to the hoses or pipes inside the vehicle that carry the medium to be heated.

The housing base part may form a first inlet channel section communicating with the inlet nozzle and/or a first outlet channel section communicating with the outlet nozzle. The fluid housing may form a second inlet channel section aligned flush with the first inlet channel section and/or a second outlet channel section aligned flush with the first outlet channel section. In this respect, the second inlet channel section and/or the first outlet channel section is usually provided downstream of the distributor in the flow direction. The first inlet channel section and the first outlet channel section are assigned to the first heating chamber. The second inlet channel section and the second outlet channel section are assigned to the second heating chamber. The inlet and outlet channel sections, which merge into one another, enable the partial flow introduced into the fluid housing to be transferred with a low pressure loss.

The nozzles can be aligned with the channel sections. Usually, the nozzles and the channel sections provide a flow of the medium at right angles to the layers of the electrical heating device.

In order to build up a certain flow resistance, which ensures that a sufficient partial flow is introduced into or discharged from the first heating chamber via the distributor, the nozzles usually provided on the outside of the housing can be offset in relation to the inlet and outlet channels. The offset deflects the flow transversely so that the introduced flow is distributed equally between the first and second heating chamber with low flow resistance. It is not necessary for the nozzles to extend at right angles to the plane containing the heating device.

The formation of two distributing bodies in the distributor, one of which is arranged upstream of the inlet branches of the two heating chambers and the other downstream of the outlet branches of the two heating chambers, has various advantages.

1. Both distributing bodies cause a change in the pressure drop of a flow of medium through the two heating chambers. By being able to make changes to both distributing bodies, it is possible to set the distribution of the medium to the two partial flows even more precisely.

2. Both distributing bodies are configured identically. In principle, this allows the electrical heating device to be supplied both with the medium fed in through the inlet referred to here as the inlet and/or inlet nozzle (when discharged through the outlet referred to here as the outlet and/or outlet nozzle) and with the medium fed in through the outlet referred to here as the outlet and/or outlet nozzle (when discharged through the outlet referred to here as the inlet and/or inlet nozzle). This gives more freedom of movement when installing the electrical heating device, which is an advantage which is particularly important given the usually limited installation space in vehicles.

### BRIEF DESCRIPTION OF THE DRAWINGS

Further details and advantages of the present invention will become apparent from the following description of an embodiment in conjunction with the drawing. Therein it is shown by:

FIG. 1: a perspective exploded view of a first embodiment of the present invention;

FIG. 2: a perspective exploded view of the housing base part and the heating chamber cover of the first embodiment according to FIG. 1;

FIG. 3: a perspective exploded view of the fluid housing of the first embodiment according to FIG. 1;

FIG. 4: a perspective top view of the housing base part partially equipped with components of the first embodiment according to FIG. 1;

FIG. 5: a sectional view of the first embodiment along the line V-V drawn in FIG. 4;

FIG. 6: a perspective view of a detail of the first embodiment of the present invention;

FIG. 7: a sectional view of the detail of the first embodiment shown in FIG. 6;

FIG. 8: a perspective view of a detail of a second embodiment of the present invention; and

FIG. 9: a sectional view of the detail of the second embodiment of the present invention.

### DETAILED DESCRIPTION

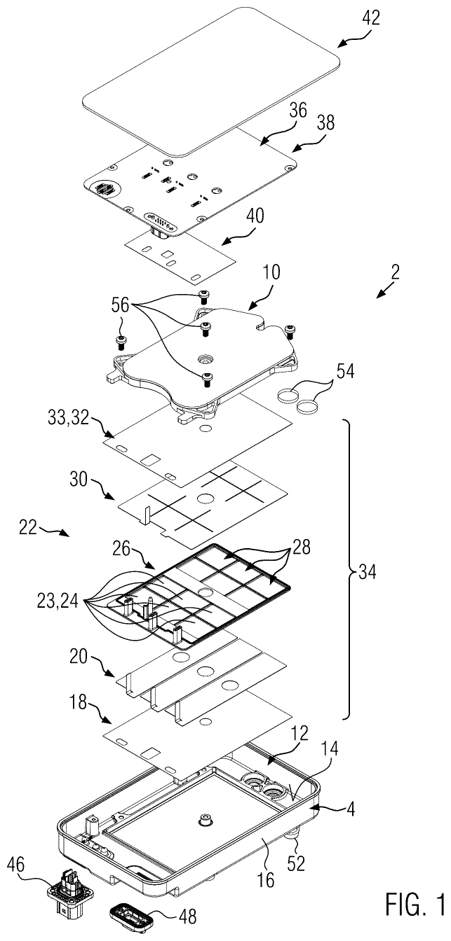

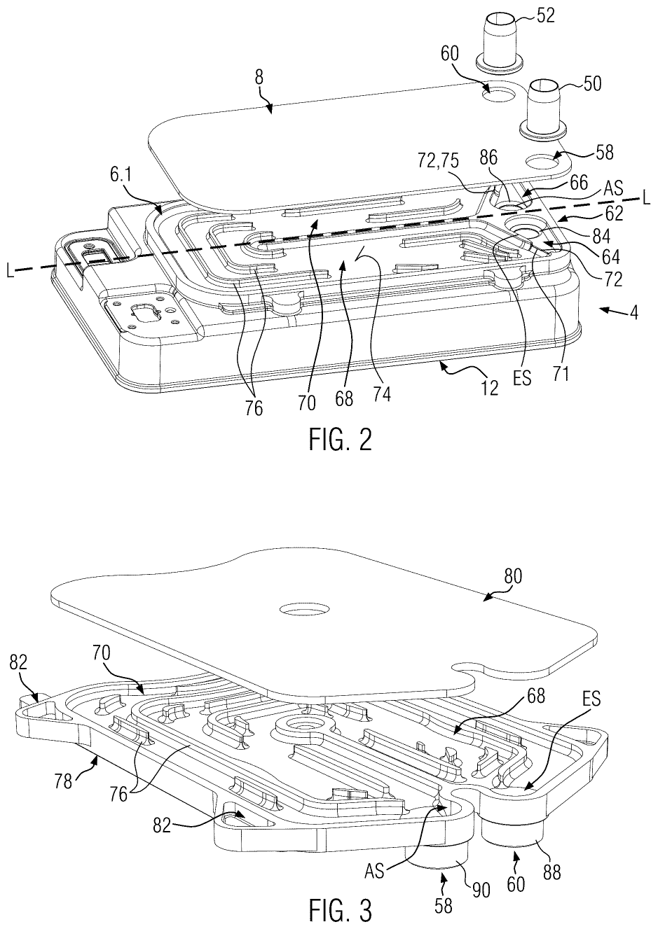

FIG. 1 shows an electrical heating device 2 with a housing base part 4, which is connected to a heating chamber cover 8 on its lower side in FIG. 1 to form a first heating chamber 6.1—see FIG. 2. Reference sign 10 characterizes a fluid housing, which is accommodated in an accommodation space 12 formed by the housing base part 4. In this accommodation space 12, which is bounded on the lower side by a bottom 14 and on the peripheral sides by a circumferential wall 16 extending from the bottom 14, and between the bottom 14 and the fluid housing 10, there is a first insulating layer 18, which can be abutted against the bottom 14, a first contacting layer 20 and a heating assembly 22 with a plurality of heating elements 23, in the present case in the form of PTC elements 24, and a positioning frame 26 with accommodations 28 for accommodating the PTC elements 24.

On the side opposite the first contacting layer 20 of the heating assembly 22, a second contacting layer 30 is provided, on the side of which opposite the heating assembly 22 a second insulating layer 32 is arranged. The PTC elements are therefore applied electrically conductive against the contacting layers 20, 30 and are energized via the same. The PTC elements 24 are ceramic cuboid components, which are provided with a metallization on opposite main side surfaces for current conduction. The main side surface is the surface of the cuboid with the largest surface area. The main side surfaces are connected to each other by peripheral surfaces that define the height of the PTC elements and have no metallization. The main side surfaces are generally each larger by a factor of 5 than one of the peripheral surfaces, typically than the sum of all the peripheral surfaces.

The second insulating layer 32 is formed as a biasing device 33 by a silicone film, which is capable of absorbing certain compressions by elastic deformation and thus arranging the electrical heating assembly 22 between the housing base part 10 and the housing bottom 14 and bias the same against the housing base part 10 and the housing bottom 14.

The layering of the first insulating layer 18, the first contacting layer 20, the heating device 21, the second contacting layer 30 and the second insulating layer 32 is hereinafter also referred to as a layered structure 34.

On the side of the fluid housing 10 facing away from this layered structure 34, in the embodiment shown, a transistor insulation 40 is located between a printed circuit board 38 forming a control device 36 and the fluid housing 10. Reference sign 42 characterizes a housing cover which is connected to the housing base part 4 to form a housing characterized by reference sign 44 in FIG. 5. The housing base part 4 and the housing cover 42, possibly further housing parts, are configured to be shielding, that is, made of metal and/or provided with a separate shielding inside, outside or in the walls of the respective housing part, which are conceivably made of plastic. A possible metallic material is aluminum or, with a view to corrosion resistance, stainless steel.

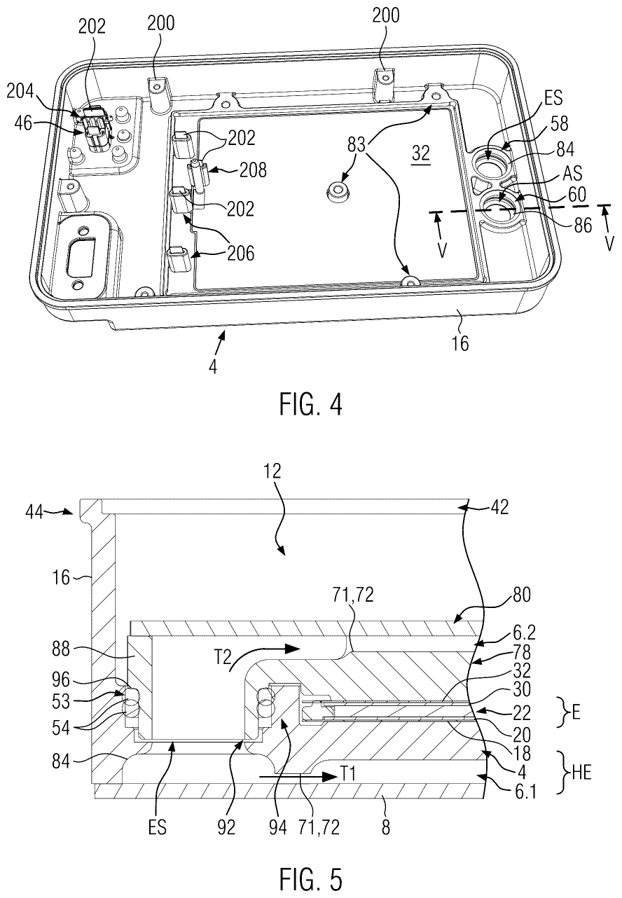

A power connector 46 and a control connector 48 are shown in FIG. 1 on the lower side of the housing base part 4 opposite this housing cover 42. These two connectors 46, 48 are connected to the housing base part 4 in a sealed manner and have various male electrical plug contacts which are led through the respective housings of the connectors 46, 48 in a sealed manner and are plug-contacted in the printed circuit board 38 and are electrically connected to strip conductors of the printed circuit board 38 via this plug contacting. Details of this are described below in conjunction with FIG. 4. For the plug contacting, the printed circuit board 38 has female contact tongue receptacles, which are described in EP 2 236 330 A1.

Furthermore, inlet and outlet nozzles 50, 52 are provided on the lower side for the connection of pipes or hoses which carry the fluid to be heated. Reference sign 53 characterizes the seal arrangement shown in FIG. 1 below the fluid housing 10, which in the present case is formed by two sealing rings 54, which are explained in more detail below. Reference sign 56 characterizes screws for fixing the fluid housing 10 opposite the housing base part 4 with interposition of the layered structure 34. Through this screw connection, the layers of the layered structure 34 are biased against the fluid housing 10 and the bottom 14 of the housing base part 4.

FIG. 2 shows an exploded view of the housing base part 4 and the heating chamber cover 8, which is shown spaced apart therefrom, and reveals the interior of the first heating chamber 6.1. It can be seen that the nozzles 50, 52 are formed by separate components which are flush with two bores within the heating chamber cover 8 formed from a flat sheet metal, one of which bores forms an inlet 58 and the other an outlet 60. The nozzles 50, 52 may be welded or bonded to the heating chamber cover 8.

Reference sign 62 characterizes a distributor arranged in a plane HE containing the first heating chamber 6.1. The distributor 62 has an inlet distributor section 64 and an outlet distributor section 66, which are each provided separately from each other and covered by the heating chamber cover 8. The respective distributor sections 64, 66 are provided symmetrically with respect to a longitudinal axis L of the housing base part 4 and are associated with an inlet branch 68 and an outlet branch 70 of the first heating chamber 6.1, respectively. In the top view, the distributor sections 64, 66 each have an approximately triangular ground area. Each distributor section 64, 66 merges into the respective branch 68, 70 via a distributing body 71 formed as an overflow edge 72. The distributing body 71 formed as an overflow edge 72 lies in the height direction between a first heating chamber bottom 74 of the first heating chamber 6.1 and an opposite cover surface of the first heating chamber 6.1 formed by the heating chamber cover 8.

Flow guide ribs 76 project from this first heating chamber bottom 74 to guide the flow, against which the heating chamber cover 8 abuts in a fluid-tight manner.

The inlet 58 or the outlet 60 in each case is arranged such that it partially covers the first heating chamber 6.1 and partially covers the respective distributor section 64, 66. The distributing body 71, which is configured as an overflow edge 72, passes approximately centrally through the bore forming the inlet 58 or the outlet 60.

Details of the second heating chamber 6.2 can be seen in FIG. 3. The fluid housing 10 is formed by a fluid housing base part 78 and a fluid housing cover 80 welded thereto. The second heating chamber 6.2 also comprises flow guide ribs 76. A plurality of fastening eyes 82 are provided on the circumference of the fluid housing 10, through which the screws 56 are guided in order to connect the fluid housing 10 to the housing bottom 14 with the electrical heating assembly 22 interposed. In FIG. 4, threads formed on the housing bottom 14 are characterized by reference sign 83.

In FIG. 4, reference sign 84 characterizes a first inlet channel section and reference sign 86 characterizes a first outlet channel section. These channel sections 84, 86 are formed on and through the housing base part 4. FIG. 3 shows second inlet and outlet channel sections 88, 90 formed integrally on the fluid housing base part 78. The first inlet channel section 84 and the second inlet channel section 88 form an inlet flow connection ES. The first outlet channel section 86 and the second outlet channel section 90 form an outlet flow connection AS. Inlet flow connection ES and outlet flow connection AS are shown in FIGS. 2 to 4, the inlet flow connection ES is also shown in FIG. 5.

As conveyed in particular by FIG. 5, the second channel sections 88, 90 are formed as tip ends 92, each engaging a bushing end 94 formed by the first channel sections 84, 86, wherein the seal arrangement 53 is provided therebetween and abuts in an axial and radial direction against an abutment shoulder 96 provided on the respective tip end 92.

The tip end 92 and the bushing end 94 have an axial length such that electrical heating assemblies 22 having different thicknesses can be arranged between the fluid housing 10 and the housing bottom 14, without loss of sealing between the housing base part 4 and the fluid housing 10. As a result, an inlet flow connection ES formed by the inlet channel sections 84, 86 is variable in length transverse to the plane E containing the electrical heating assembly 22. The same applies to an outlet flow connection characterized by reference sign AS. In this context, inlet flow connection ES and outlet flow connection AS penetrate the plane E.

The fluid flow introduced into the electrical heating device 2 through the inlet 58 is divided in a blade-like manner into two partial flows in the area of the distributor 62 by the distributing body 71 formed as an overflow edge 72 in this first embodiment. A further distributing body 75 corresponding to the distributing body 71 is formed opposite the outlet 60 and the outlet nozzle 52. The further distributing body 75 is configured like the distributing body 71, in this case as an overflow edge 72. The positioning of the further distributing body 75 relative to the outlet 60 and the outlet nozzle 52 is analogous to the positioning of the distributing body 71 relative to the inlet 58 and the inlet nozzle 50. The first partial flow T1 flows via the overflow edge 72 into the first heating chamber 6.1, whereas the second partial flow T2 passes through the inlet flow connection ES, flows through the second heating chamber 6. 2, first through the inlet branch 68 and then through the outlet branch 70, and finally through the outlet flow connection AS, is brought together with the first partial flow T1 in the area of the distributor 62 and the fluid flow resulting from the combination of these two partial flows T1, T2 is discharged through the outlet. When the partial flows T1, T2 are combined, they flow via the further distributing body 75 and then through the outlet 60 into the outlet nozzle 52 and through the latter out of the electrical heating device 1.

FIG. 4 also conveys the electrical connection concept for the printed circuit board 38. Contact tongues 202 of male plug contacts 204, which are exposed at the free ends of the connectors (only the power connector 46 is shown) or at the free ends of terminal lugs 206 of the minus contacts or at the free ends of terminal lugs 208 of the plus contact, protrude into a mounting plane of the printed circuit board 38, which is recognizable by supports 200 for the printed circuit board 38. The terminal lugs 206, 208 also protrude beyond the fluid housing 10 after assembly, which is arranged below the mounting plane of the printed circuit board 38. The printed circuit board 38 can be plug-contacted with all contact tongues 202 by simply lowering it in the direction of the housing bottom 14, that is, in a direction orthogonal to the flat extension of the housing bottom 14. The mounted printed circuit board 38 rests on the supports 200 and is fixed against the housing base part 2 by means of screws, not shown, which are engaged in threads of the supports 200.

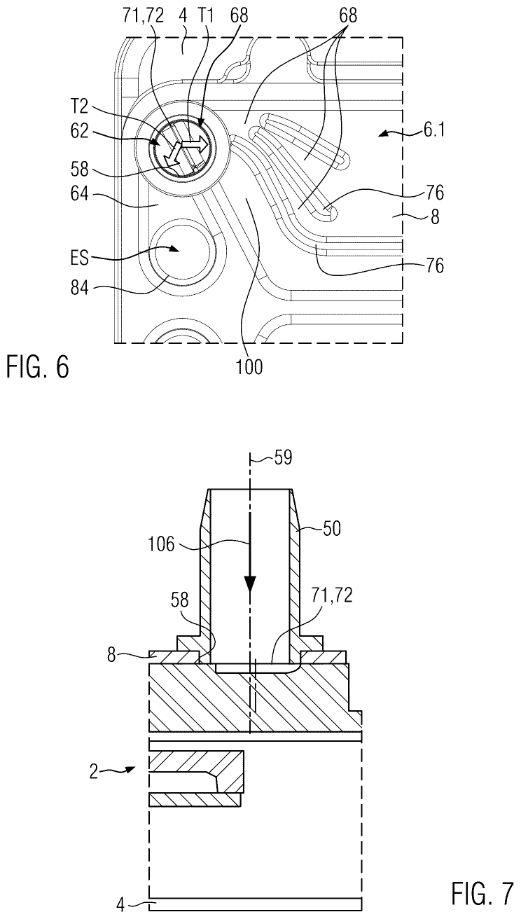

FIG. 6 shows a perspective view of the area of the distributor 62 in the first embodiment of the present invention. Reference is made to the above description, in particular of FIG. 2, in order to avoid repetition. Here, the housing base part 4 is shown in a bottom view, wherein the heating chamber cover 8 is shown partially transparent. The distributor 62 comprises the distributing body 71, which in this embodiment is configured as an overflow edge 72. FIG. 7 shows a section along the overflow edge 72. FIGS. 6 and 7 are described together below, unless explicit reference is made to one of the Figures.

During operation, medium flows into the distributor 62 via the inlet 58 in the inflow direction 106 (FIG. 7). The medium impinges there on the distributing body 71 formed as an overflow edge 72, which passes centrally through the inlet 58. This means (see in particular FIG. 6) that the projection of the inlet 58 is divided centrally by the overflow edge 72 into two equal parts. As a result, a first partial flow T1 is formed, which flows into the inlet branch 68 of the first heating chamber 6.1 (FIG. 6). In this context, the flow in the first heating chamber 6.1 is guided by the flow ribs 76. The second partial flow T2 flows into the second heating chamber 6.2 via the inlet distributor section 64 and the inlet flow connection ES (FIG. 6).

The overflow edge 72 is configured as a thin edge which divides the flow of the medium through the inlet 58 into the first partial flow T1 and the second partial flow T2 in a blade-like manner. The distributing body 71 is configured such that the partial flows T1, T2 are essentially the same size and differ from each other by at most 10%, so that approximately 45% to 55% of the inflowing medium forms the first partial flow T1 and the remainder forms the second partial flow T2.

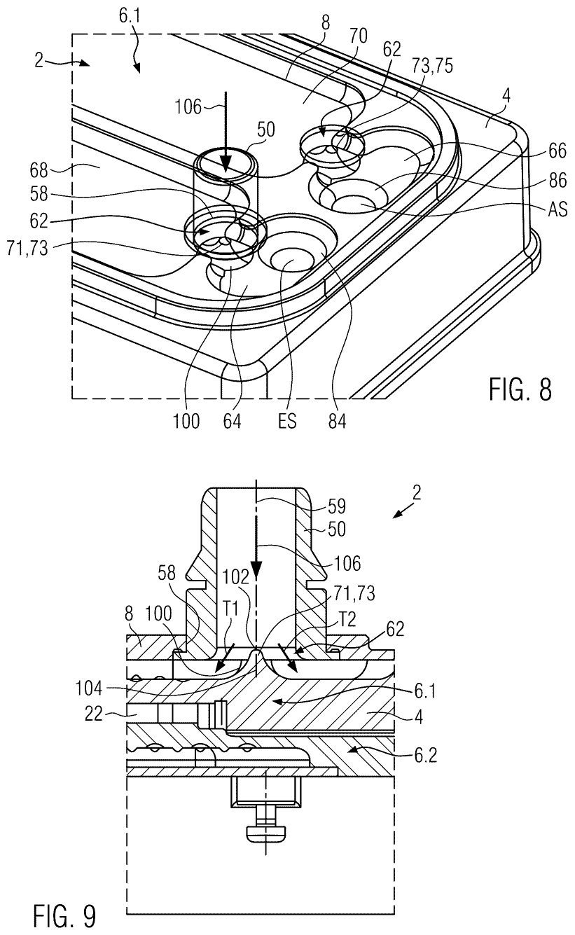

FIGS. 8 and 9 show a second embodiment of the present invention, which differs from the first embodiment in the shape of the distributing body 71 and the further distributing body 75 in the distributor 62. In the following, only the differences to the first embodiment are described, otherwise, in order to avoid repetition, reference is made to the above explanations. FIG. 8 shows a perspective bottom view of the electrical heating device 2, in which the heating chamber cover 8 is shown partially transparent, while FIG. 9 shows a sectional view of the electrical heating device 2 in the area of the distributor 62. FIGS. 8 and 9 are described together below if no explicit reference is made to one figure. Furthermore, the distributing body 71 is described in detail below. The further distributing body 75 has the same shape and size. The position of the further distributing body 75 relative to the outlet 60, to the outlet nozzle 52, to the outlet distributor section 66 and to the outlet flow connection AS is thereby identical to the position of the distributing body 71 relative to the inlet 58, to the inlet nozzle 50, to the inlet distributor section 64 and to the inlet flow connection ES.

In the second embodiment, the distributing body 71 is configured as a rotationally symmetrical conical body 73. The conical body 73 is characterized by a rotationally symmetrical shape about an axis of symmetry 104 (see FIG. 9). In this embodiment, the conical body 73 is not a straight cone; rather, the conical body 73 has a shell surface 100 that is concave. In the second embodiment, the axis of symmetry 104 is identical to an inlet axis 59 (FIG. 9), which penetrates centrally through the circular inlet 58 in the heating chamber cover 8. At the same time, the inlet axis 59 is also the axis of symmetry of the inlet nozzle 50 and the inlet 58. The conical body 73 is formed centrally to the inlet 58, the inlet axis 59 intersects a tip 102 (FIG. 9), so that a medium flowing in an inflow direction 106, which points downwards parallel to the inlet axis 59, through the inlet nozzle 50 and the inlet 58 into the distributor 62 impinges centrally on the conical body 73.

The use of a conical body 73 as distributing body 71 ensures efficient and good deflection and division of the flow into the two partial flows T1, T2 and towards the inlet branch 68 of the first heating chamber 6.1 and to the inlet distributor section 64 and via this to the inlet flow connection ES (FIG. 8) and via this into the second heating chamber 6. 2. in particular by adapting the concave shell surface 100, good adaptability to the flow conditions in the first heating chamber 6.1 and the second heating chamber 6.2 is provided, so that two partial flows T1, T2 of essentially equal size can be achieved.

FIG. 9 shows an alternative configuration of the inlet nozzle 50 compared to the other Figures of this document, which is interchangeable with the configuration of the inlet nozzle 50 and the outlet nozzle 52 shown in the other Figures. In this invention, inlet nozzle 50 and outlet nozzle 52 may be connected to the heating chamber cover 8 in a material-locking manner, in particular bonded, soldered and/or welded.

The present invention relates to an electrical heating device 2, which has two heating chambers 6.1, 6.2, between which an electrical heating assembly 22 is formed. A distributor 62 is used to divide a flow of a medium to be heated entering the electrical heating device 2 in the inflow direction 106 into a first partial flow T1 and a second partial flow T2. The first partial flow T1 flows through the first heating chamber 6.1, while the second partial flow T2 flows through the second heating chamber 6.2. For this purpose, the distributor 62 has a distributing body 71, which may be configured as a conical body 73 that is rotationally symmetrical about an axis of symmetry 104. The axis of symmetry 104 may be parallel to an inlet axis 59. Alternatively, the distributing body 71 can also be configured as an overflow edge 72.

1. An electrical heating device for heating a liquid medium, comprising:
a first heating chamber;
a second heating chamber;
an electrical heating assembly which is provided between the first heating chamber and the second heating chamber and which is coupled to the first heating chamber and the second heating chamber in a heat-conducting manner; and
a distributor through which the medium is distributed between the first heating chamber and the second heating chamber, wherein the distributor comprises a distributing body through which the medium introduced into the distributor is divided into a first partial flow which is guided into the first heating chamber and a second partial flow which is guided into the second heating chamber.

2. The electrical heating device according to claim 1, wherein an overflow edge is formed as a distributing body.

3. The electrical heating device according to claim 2, wherein the overflow edge passes centrally through an inlet into the distributor.

4. The electrical heating device according to claim 1, wherein the distributing body is a conical body which is rotationally symmetrical with respect to an axis of symmetry.

5. The electrical heating device according to claim 4, wherein the axis of symmetry corresponds to a flow direction of the medium into the distributor.

6. The electrical heating device according to claim 4, wherein the conical body has a concave shell surface.

7. The electrical heating device according to claim 4, wherein an inlet to the distributor is formed symmetrically to an inlet axis and the inlet axis forms the axis of symmetry of the conical body.

8. The electrical heating device according to claim 4, wherein the conical body is formed centrally to an inlet to the distributor.

9. The electrical heating device according to claim 1, wherein the distributing body is configured such that the two partial flows differ from each other by a maximum of 10%.

10. The electrical heating device according to claim 9, wherein the distributing body is configured such that the two partial flows differ from each other by a maximum of 2%.

11. The electrical heating device according to claim 1, wherein the distributor is formed in a plane containing the first heating chamber.

12. The electrical heating device according to claim 11, wherein the distributor is connected to an inlet flow connection and to an outlet flow connection connecting the distributor to the second heating chamber, and wherein the inlet flow connection and the outlet flow connection extend in a direction transverse to a plane containing the heating device and penetrate the plane containing the heating device.

13. The electrical heating device according to claim 12, wherein the distributor comprises an inlet distributor section extending between the distributing body and the inlet flow connection in the plane containing the first heating chamber.

14. The electrical heating device according to claim 12, wherein the distributor comprises an outlet distributor section extending between the distributing body and the outlet flow connection in the plane containing the first heating chamber.

15. The electrical heating device according to claim 14, wherein the distributor sections are arranged axially symmetrically to one another.

16. The electrical heating device according to claim 12, wherein the distributor sections have an approximately triangular ground area in a top view of the plane containing the first heating chamber, and wherein the tip of the approximately triangular ground area is rounded, and the respective flow connections are provided opposite thereto.

17. The electrical heating device according to claim 1, wherein the heating assembly comprises at least one PTC element.

18. The electrical heating device according to claim 1, wherein partial flows coming from the first heating chamber and from the second heating chamber are brought together by the distributor.

19. The electrical heating device according to claim 1, wherein the first heating chamber is formed between 1) a housing bottom of a housing base part forming an inlet and an outlet for the medium and 2) a heating chamber cover which is connected to the housing base part, wherein the second heating chamber is formed by a fluid housing, and wherein the housing base part forms the distributor.

20. The electrical heating device according to claim 18, wherein the housing base part is connected to an inlet nozzle leading to the inlet and to an outlet nozzle leading to the outlet wherein the housing base part forms a first inlet channel section communicating with at least one of the inlet nozzle and a first outlet channel section communicating with the outlet nozzle, wherein the fluid housing forms a second inlet channel section that is aligned flush with the first inlet channel section and a second outlet channel section that is aligned flush with the first outlet channel section, and wherein the second inlet channel section and the first outlet channel section are provided downstream of the distributor in a direction of medium flow.
